(19) United States
(12) Patent Application Publication
(10) Pub. No.: US 2024/0150916 A1
(43) Pub. Date: May 9, 2024

(54) WATER ELECTROLYSIS SYSTEM

(71) Applicant: TOYOTA JIDOSHA KABUSHIKI KAISHA, Toyota-shi (JP)

(72) Inventor: Kohsei YOSHIDA, Gotemba-shi (JP)

(73) Assignee: TOYOTA JIDOSHA KABUSHIKI KAISHA, Toyota-shi (JP)

(21) Appl. No.: 18/466,334

(22) Filed: Sep. 13, 2023

(30) Foreign Application Priority Data
Nov. 4, 2022 (JP) 2022-176996

(51) Int. Cl. C25B 15/023; C25B 1/04

(52) U.S. Cl. CPC C25B 15/023; C25B 1/04

(57) ABSTRACT

In the water electrolysis system, a hydrogen pressure in a water electrolysis cell is measured, a 1 voltage in a 1 current during normal operation of the water electrolysis cell is measured when the hydrogen pressure is within a normal range, and when the 1 voltage exceeds a 1 normal cell voltage threshold in the 1 current, a 1 resistance of the water electrolysis cell is calculated from an inclination of a voltage of the water electrolysis cell obtained by sweeping a predetermined current to the water electrolysis cell. A water electrolysis system, wherein when the 1 resistance is higher than a predetermined resistance threshold, an abnormality of the water electrolysis cell is determined, and an operation of the water electrolysis cell is stopped.

### CROSS-REFERENCE TO RELATED APPLICATION

This application claims priority to Japanese Patent Application No. 2022-176996 filed on Nov. 4, 2022 incorporated herein by reference in its entirety.

### BACKGROUND

### 1. Technical Field

The present disclosure relates to a water electrolysis system.

### 2. Description of Related Art

Various studies have been made on water electrolysis devices. For example, Japanese Unexamined Patent Application Publication No. 2012-087396 (JP 2012-087396 A) discloses a technique of stopping hydrogen production by detecting a pressure abnormality using a hydrogen pressure value.

### SUMMARY

A problem arises in that when a pressure sensor fails, an abnormality cannot be detected, and a safety device (relief valve) operates due to an abnormal pressure, and the generated hydrogen is discharged (exhausted).

The present disclosure has been made in view of the above circumstances, and a main object of the present disclosure is to provide a water electrolysis system capable of detecting an abnormality in a pressure increase even when a pressure sensor fails.

The present disclosure provides a water electrolysis system in which: a hydrogen pressure in a water electrolysis cell is measured, and when the hydrogen pressure is within a normal range, a first voltage at a first current when the water electrolysis cell is in normal operation is measured; when the first voltage exceeds a first normal cell voltage threshold value at the first current, a first resistance of the water electrolysis cell is calculated from a slope of a voltage of the water electrolysis cell that is obtained by sweeping a predetermined current to the water electrolysis cell; and when the first resistance is higher than a predetermined resistance threshold value, determination is made that the water electrolysis cell is abnormal, and an operation of the water electrolysis cell is stopped.

In the present disclosure: when the determination is made that the water electrolysis cell is abnormal, the operation of the water electrolysis cell may not be stopped, and a second voltage at a second current smaller than the first current of the water electrolysis cell may be measured; when the second voltage exceeds a second normal cell voltage threshold value at the second current, a second resistance of the water electrolysis cell may be calculated from the slope of the voltage of the water electrolysis cell obtained by sweeping the predetermined current to the water electrolysis cell; and when the second resistance is higher than a predetermined resistance threshold value, the determination may be made that the water electrolysis cell is abnormal, and the operation of the water electrolysis cell may be stopped.

In the present disclosure: the water electrolysis system may include the water electrolysis cell, a control unit, a pressure sensor, and a voltage sensor; the pressure sensor may measure the hydrogen pressure in the water electrolysis cell; when the control unit determines that the hydrogen pressure is within the normal range, the voltage sensor may measure the first voltage at the first current when the water electrolysis cell is in the normal operation; when the control unit determines that the first voltage exceeds the first normal cell voltage threshold value at the first current, the control unit may calculate the first resistance of the water electrolysis cell from the slope of the voltage of the water electrolysis cell obtained by sweeping the predetermined current to the water electrolysis cell; and when the first resistance is higher than the predetermined resistance threshold value, the control unit may determine that the water electrolysis cell is abnormal and stop the operation of the water electrolysis cell.

The water electrolysis system of the present disclosure can detect an abnormality in the pressure increase even when the pressure sensor fails.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an example of a water electrolysis system of the present disclosure;

FIG. 2 is a flow chart illustrating an exemplary control of the disclosed water electrolysis system; and

FIG. 3 is a flowchart illustrating another example of control of the water electrolysis system of the present disclosure.

### DETAILED DESCRIPTION OF EMBODIMENTS

Embodiments according to the present disclosure will be described below. It should be noted that matters other than those specifically mentioned in the present specification and necessary for the implementation of the present disclosure (for example, a general configuration and a manufacturing process of a water electrolysis system that does not characterize the present disclosure) can be understood as design matters of a person skilled in the art based on the prior art in the field. The present disclosure may be carried out based on the content disclosed in the present specification and the common general technical knowledge in the field. In the present specification, “to” indicating a numerical range is used in a sense including numerical values described before and after the numerical range as a lower limit value and an upper limit value. Any combination of the upper limit value and the lower limit value in the numerical range can be adopted.

The present disclosure provides a water electrolysis system in which: a hydrogen pressure in a water electrolysis cell is measured, and when the hydrogen pressure is within a normal range, a first voltage at a first current when the water electrolysis cell is in normal operation is measured; when the first voltage exceeds a first normal cell voltage threshold value at the first current, a first resistance of the water electrolysis cell is calculated from a slope of a voltage of the water electrolysis cell that is obtained by sweeping a predetermined current to the water electrolysis cell; and when the first resistance is higher than a predetermined resistance threshold value, determination is made that the water electrolysis cell is abnormal, and an operation of the water electrolysis cell is stopped.

In the water electrolysis system of the present disclosure, when it is determined that the water electrolysis cell is abnormal, the operation of the water electrolysis cell is not stopped, the second voltage at the second current smaller than the first current of the water electrolysis cell is measured, and when the second voltage exceeds the second normal cell voltage threshold of the second current, the second resistance of the water electrolysis cell is calculated from the slope of the voltage of the water electrolysis cell obtained by sweeping the predetermined current to the water electrolysis cell, and when the second resistance is higher than the predetermined resistance threshold, the abnormality of the water electrolysis cell is determined, and the operation of the water electrolysis cell may be stopped.

In the present disclosure, it is possible to provide a method for detecting a pressure abnormality in a water electrolysis cell without using a pressure sensor value when a pressure sensor fails.

The water electrolysis system of the present disclosure may include a water electrolysis cell, a control unit, a pressure sensor, and a voltage sensor.

In the water electrolysis cell, a plurality of the water electrolysis cells may be stacked to form a water electrolysis cell stack (hereinafter, sometimes referred to as a stack). The number of stacked water electrolysis cells is not particularly limited, and may be, for example, 2 to several hundred. In the water electrolysis cell of the present disclosure, water supplied to an anode (oxygen electrode) is electrolyzed, oxygen is generated from the anode, and hydrogen is generated from the cathode (hydrogen electrode).

Anode: H₂O→2H⁺+½O₂+2e⁻

Cathode: 2H⁺+2e⁻→H₂

The water electrolysis cell may include two separators having at least an electrode portion and sandwiching the electrode portion as necessary. The electrode portion includes an anode-side gas diffusion layer, an anode catalyst layer, an electrolyte membrane, a cathode catalyst layer, and a cathode-side gas diffusion layer in this order.

The cathode (hydrogen electrode) includes a cathode catalyst layer and a cathode-side gas diffusion layer. The anode (oxygen electrode) includes an anode catalyst layer and an anode-side gas diffusion layer.

The cathode catalyst layer and the anode catalyst layer are collectively referred to as a catalyst layer. The catalyst layer may include, for example, a catalyst metal that promotes water electrolysis, an electrolyte having proton conductivity, a support having electron conductivity, and the like. As the catalytic metal, for example, iridium (Ir), iridium dioxide (IrO₂), ruthenium (Ru), platinum (Pt), and an alloy composed of Pt and another metal (for example, a Pt alloy obtained by mixing cobalt, nickel, and the like) can be used. As the anode catalyst layer, for example, Ir, iridium dioxide (IrO₂), Ru, or the like may be used as the catalyst metal, and as the catalyst metal, for example, Pt, and Pt alloy, or the like may be used as the cathode catalyst layer. The electrolyte may be fluorine-based resin or the like. As the fluorine-based resin, for example, Nafion solution or the like may be used. The catalyst metal is supported on a carrier, and each catalyst layer may contain a mixture of a carrier supporting the catalyst metal (catalyst-supporting carrier) and an electrolyte. Examples of the carrier for supporting the catalyst metal include commercially available carbon materials such as carbon.

The electrolyte membrane may be a solid polymer electrolyte membrane. Examples of the solid polymer electrolyte membrane include fluorine-based electrolyte membranes such as perfluorosulfonic acid thin films containing water, and hydrocarbon-based electrolyte membranes. As the electrolyte membrane, for example, a Nafion membrane (produced by DuPont) may be used.

The cathode-side gas diffusion layer and the anode-side gas diffusion layer are collectively referred to as a gas diffusion layer (GDL). The gas diffusion layer may be a gas permeable, that is, a conductive member having pores. Examples of the electroconductive member include porous carbon bodies such as carbon cloth and carbon paper, and porous metal bodies such as metal mesh and metal foam.

The anode separator and the cathode separator are collectively referred to as a separator. The cathode separator is disposed adjacent to a surface of the cathode-side gas diffusion layer opposite to the cathode catalyst layer. The anode separator is disposed adjacent to a surface of the anode-side gas diffusion layer opposite to the anode catalyst layer. Two separators, an anode separator and a cathode separator, sandwich the resin frame and the electrode portion. The separator may have holes serving as manifolds such as supply holes and discharge holes for allowing fluids such as reaction water, oxygen, hydrogen, and a cooling medium to flow in the stacking direction of the water electrolysis cell. As the reaction water and the cooling medium, water, pure water, or the like can be used. Examples of the supply hole include an anode supply hole, a cathode supply hole, and a cooling medium supply hole. Examples of the discharge hole include an anode discharge hole, a cathode discharge hole, and a cooling medium discharge hole. The separator may have a flow path of a reaction fluid such as reaction water, oxygen, or hydrogen on a surface in contact with the gas diffusion layer. In addition, the separator may have a flow path of a cooling medium for keeping the temperature of the water electrolysis cell constant on the surface opposite to the surface in contact with the gas diffusion layer. The anode separator may have a flow path of an anode fluid such as reactive water or oxygen on a surface in contact with the anode-side gas diffusion layer. In addition, the anode separator may have a flow path of a cooling medium for keeping the temperature of the water electrolysis cell constant on the surface opposite to the surface in contact with the anode-side gas diffusion layer. The cathode separator may have a flow path of a cathode fluid such as hydrogen on a surface in contact with the cathode-side gas diffusion layer. In addition, the cathode separator may have a flow path of a cooling medium for keeping the temperature of the water electrolysis cell constant on the surface opposite to the surface in contact with the cathode-side gas diffusion layer. The separator may be a gas-impermeable electroconductive member or the like. The gas-impermeable conductive member may be, for example, dense carbon obtained by compressing a resin material such as a thermosetting resin, a thermoplastic resin, and a resin fiber, and a carbon material such as a carbon powder and a carbon fiber to make it gas-impermeable, or a press-molded metal (for example, titanium, stainless steel, or the like) plate. The shape of the separator may be a rectangle, a horizontally long hexagon, a horizontally long octagon, a circle, an oblong shape, and the like.

The water electrolysis cell may typically comprise a resin frame. The resin frame is disposed on the outer periphery of the electrode portion and is disposed between the cathode separator and the anode separator. The resin frame may have a framework portion, an opening portion, and a hole. The skeleton portion is a main portion of the resin frame connected to the electrode portion. The opening portion is a holding region of the electrode portion, and is a region penetrating a part of the skeleton portion for accommodating the electrode portion. The opening portion may be disposed at a position where the skeleton portion is disposed in the periphery (outer peripheral portion) of the electrode portion in the resin frame, and may be provided at the center of the resin frame. The holes of the resin frame allow a fluid such as reaction water, oxygen, hydrogen, and a cooling medium to flow in the stacking direction of the water electrolysis cell. The holes in the resin frame may be aligned and arranged to communicate with the holes in the separator. The resin frame may include a frame-shaped core layer and two frame-shaped shell layers provided on both sides of the core layer, that is, a first shell layer and a second shell layer. The first shell layer and the second shell layer may be provided in a frame shape on both sides of the core layer, similarly to the core layer.

The core layer may be a structural member having a gas sealing property and an insulating property, and may be formed of a material whose structure does not change even under a temperature condition at the time of thermocompression bonding in the manufacturing process of the water electrolysis cell. Specifically, the material of the core-layer may be, for example, a resin such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyether sulfone (PES), polyphenyl sulfone (PPSU), liquid crystal polymer (LCP), or epoxy resin. The core-layer material may be a rubber material such as ethylene propylene diene rubber (EPDM), fluorine-based rubber, or silicone-based rubber. The thickness of the core layer may be 5 μm or more, 20 μm or more, or 200 μm or less, or 150 μm or less, from the viewpoint of reducing the thickness of the water electrolysis cell, from the viewpoint of ensuring the insulating property.

The first shell layer and the second shell layer may have a high adherence property to other materials, have a property of softening under a temperature condition during thermocompression bonding and having a lower viscosity and melting point than the core layer, in order to adhere the core layer with the anode separator and the cathode separator and ensure a sealing performance. Specifically, the first shell layer and the second shell layer may be a thermoplastic resin such as a polyester-based thermoplastic resin and a modified olefin-based thermoplastic resin, or may be a thermosetting resin that is a modified epoxy resin. The resin that constitutes the first shell layer and the resin that constitutes the second shell layer may be the same type of resin or different types of resin. By providing the shell layers on both sides of the core layer, it becomes easier to adhere the resin frame and the two separators by hot pressing. The thickness of the shell layer of each of the first shell layer and the second shell layer may be 5 μm or more, 30 μm or more, or 100 μm or less, or 40 μm or less, from the viewpoint of reducing the thickness of the water electrolysis cell, from the viewpoint of ensuring adhesion.

In the resin frame, the first shell layer and the second shell layer may be provided only on the portions to be adhered to the anode separator and the cathode separator, respectively. The first shell layer provided on one side of the core layer may be adhered to the cathode separator. The second shell layer provided on the other side of the core layer may be adhered to the anode separator. Then, the resin frame may be sandwiched between the pair of separators.

In the water electrolysis cell stack, a gasket or a resin sheet may be disposed between the water electrolysis cells so as to surround each hole and ensure a gas sealing property.

The water electrolysis cell stack may include a manifold such as an inlet manifold in which the supply holes communicate with each other and an outlet manifold in which the discharge holes communicate with each other. Inlet manifolds include anode inlet manifolds, cathode inlet manifolds, and cooling medium inlet manifolds. Outlet manifolds include anode outlet manifolds, cathode outlet manifolds, and cooling medium outlet manifolds.

The pressure sensor is disposed on a hydrogen extraction channel to be described later, and measures a pressure of hydrogen in the water electrolysis cell. The pressure sensor is electrically connected to the control unit. The control unit detects the pressure of hydrogen acquired by the pressure sensor. As the pressure sensor, a conventionally known pressure gauge or the like can be used.

The voltage sensor measures the voltage of the water electrolysis cell. In the case of a water electrolysis cell stack, the voltage sensor measures the voltage of each water electrolysis cell. Since the voltage of the water electrolysis cell stack is an average value of the voltages of the water electrolysis cells, when only the voltage of the water electrolysis cell stack is measured, the abnormality of each water electrolysis cell may not be detected, and thus the voltage of each water electrolysis cell is measured. The voltage sensor is electrically connected to the control unit. The control unit detects the voltage of the water electrolysis cell acquired by the voltage sensor. As the voltage sensor, a conventionally known voltmeter or the like can be used. The voltage sensor may have a voltage measurement terminal and a wire connected to each water electrolysis cell.

The control unit may include a current control device. The current control device controls the current flowing through the water electrolysis cell. The control unit controls the operation of the water electrolysis cell. The control unit physically includes, for example, an arithmetic processing unit such as a central processing unit (CPU), a read-only memory (ROM) that stores control programs processed by CPU, control data, and the like, a storage device such as a random access memory (RAM) that is mainly used as various working areas for the control processing, and an input/output interface. The control unit may be, for example, a control device such as Electronic Control Unit (ECU).

The control unit may execute the following first control. When the control unit determines that the hydrogen pressure is within the normal range, the control unit causes the current control device to flow the first current during the normal operation of the water electrolysis cell to the water electrolysis cell. The voltage sensor measures a first voltage at a first current during normal operation of the water electrolysis cell. When the control unit determines that the first voltage exceeds the first normal cell voltage threshold value of the first current, the control unit sweeps a predetermined current to the water electrolysis cell by the current control device, and calculates the first resistance of the water electrolysis cell from the slope of the voltage of the obtained water electrolysis cell. When the first resistance is higher than the predetermined resistance threshold, the control unit determines that the water electrolysis cell is abnormal and stops the operation of the water electrolysis cell.

The control unit may execute the second control described below. When the first resistance is higher than the predetermined resistance threshold value and the control unit determines that the water electrolysis cell is abnormal, the control unit does not stop the operation of the water electrolysis cell and causes the current control device to flow a second current smaller than the first current to the water electrolysis cell. The voltage sensor measures a second voltage at a second current of the water electrolysis cell. When the control unit determines that the second voltage exceeds the second normal cell voltage threshold value of the second current, the control unit sweeps a predetermined current to the water electrolysis cell by the current control device, and calculates the second resistance of the water electrolysis cell from the slope of the voltage of the obtained water electrolysis cell. When the second resistance is higher than the predetermined resistance threshold, the control unit determines that the water electrolysis cell is abnormal and stops the operation of the water electrolysis cell.

The water electrolysis system may include an aqueous system, a hydrogen system, and an oxygen-containing gas system.

The water system may include a water supply unit, a water supply flow path, a water discharge flow path, and the like. The water supply unit may be a water storage tank or the like that stores water, pure water, or the like. The water supply flow path connects the water supply unit and the oxygen electrode of the water electrolysis cell. The water supply unit supplies water, pure water, and the like to the oxygen electrode of the water electrolysis cell via the water supply flow path. The water discharge channel may be connected to the water electrolysis cell, and unreacted water or the like discharged from the water electrolysis cell may be discharged to the outside of the water electrolysis system, or the water electrolysis cell and the water supply unit may be connected, and unreacted water or the like discharged from the water electrolysis cell may be recovered to the water supply unit.

The hydrogen system may include a hydrogen storage tank, a hydrogen extraction channel, the above-described pressure sensor (hydrogen pressure sensor), a hydrogen relief valve, and the like. The hydrogen storage tank stores hydrogen generated by water electrolysis. The hydrogen extraction channel may connect the hydrogen storage tank and the hydrogen electrode of the water electrolysis cell, and may store the hydrogen discharged from the hydrogen electrode by the water electrolysis of the water electrolysis cell in the hydrogen storage tank. The hydrogen relief valve is disposed on the hydrogen extraction channel, and opens the valve when an abnormality is detected, and discharges hydrogen to the outside of the water electrolysis system. The hydrogen relief valve is electrically connected to the control unit. The control unit controls opening and closing of the hydrogen relief valve.

The oxygen-containing gas system may include an oxygen discharge channel or the like. The oxygen discharge channel may be connected to the oxygen electrode of the water electrolysis cell, and the oxygen-containing gas discharged from the oxygen electrode by the water electrolysis of the water electrolysis cell may be exhausted to the outside of the water electrolysis system. The oxygen-containing gas may be oxygen, air, or the like. The water discharge channel may also serve as an oxygen discharge channel.

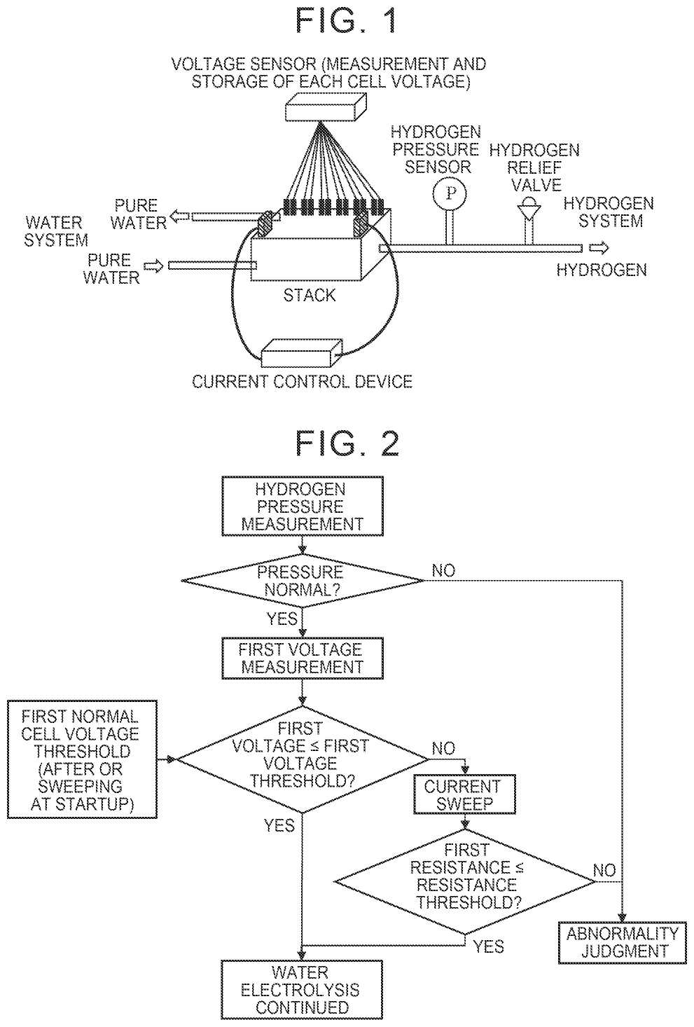

FIG. 1 is a schematic configuration diagram illustrating an example of a water electrolysis system of the present disclosure. Note that the water electrolysis system of the present disclosure is not limited to the configuration shown in FIG. 1. The water electrolysis system shown in FIG. 1 includes a stack, a current control device included in the control unit, a voltage sensor, an aqueous system, and a hydrogen system. For convenience, description of other configurations such as an oxygen-containing gas system will be omitted. The water system has a water supply channel for supplying pure water to the stack and a water discharge channel for discharging pure water from the stack. The hydrogen system includes a hydrogen extraction channel, a hydrogen pressure sensor disposed on the hydrogen extraction channel, and a hydrogen relief valve. In the stack, a voltage measurement terminal of a voltage sensor is attached to each water electrolysis cell via a wiring so that the voltage of each water electrolysis cell can be measured. The current control device controls the current of the stack. The voltage of each water electrolysis cell measured by the voltage sensor is stored in the control unit.

### First Embodiment

FIG. 2 is a flowchart illustrating an example of control of the water electrolysis system of the present disclosure.
1. The pressure sensor measures a hydrogen pressure value in the water electrolysis cell stack, and the control unit determines whether the hydrogen pressure value is within a normal range. When the hydrogen pressure value is an abnormal value, take measures (abnormal measures) in the event of an abnormality, such as stoppage of water electrolysis.
2. When the control unit determines that the hydrogen pressure value is within the normal range, the control unit causes the current control device to flow the first current during the normal operation of the water electrolysis cell, and measures the first voltage of each water electrolysis cell by the voltage sensor. The control unit compares the first voltage with the first normal cell voltage threshold value, and determines that a voltage rise has not occurred, that is, whether the first voltage is equal to or lower than the first normal cell voltage threshold value.
3. When the control unit determines that the first voltage exceeds the first normal cell voltage threshold, that is, the cell voltage is abnormal, the control unit sweeps a predetermined current to the water electrolysis cell by the current control device, and calculates the first resistance of the water electrolysis cell from the slope of the voltage of the obtained water electrolysis cell. The control unit determines whether or not the first resistance is equal to or less than a predetermined resistance threshold. When the first resistance is higher than the predetermined resistance threshold, the control unit determines that the water electrolysis cell is abnormal, and the control unit stops the operation of the water electrolysis cell as a treatment in an abnormal state. When the first resistance is equal to or less than the predetermined resistance threshold, the control unit continues the operation of the water electrolysis cell.

### Second Embodiment

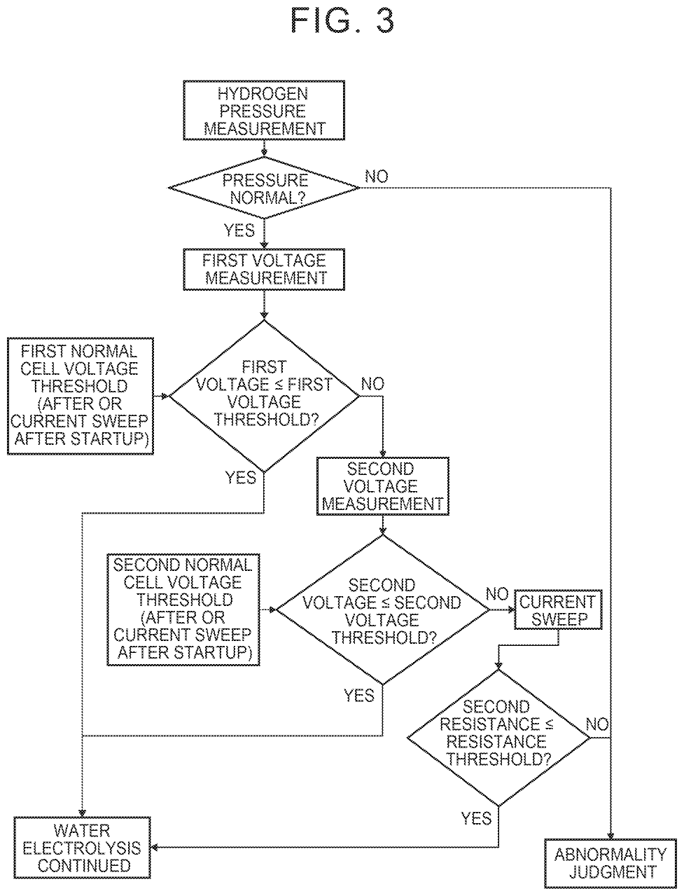

FIG. 3 is a flowchart illustrating another example of control of the water electrolysis system of the present disclosure.
1. The pressure sensor measures a hydrogen pressure value in the water electrolysis cell stack, and the control unit determines whether the hydrogen pressure value is within a normal range. When the hydrogen pressure value is an abnormal value, take measures (abnormal measures) in the event of an abnormality, such as stoppage of water electrolysis.
2. When the control unit determines that the hydrogen pressure value is within the normal range, the control unit causes the current control device to flow the first current during the normal operation of the water electrolysis cell, and measures the first voltage of each water electrolysis cell by the voltage sensor. The control unit compares the first voltage with the first normal cell voltage threshold, and determines whether or not a voltage rise has occurred, that is, whether or not the first voltage is equal to or lower than the first normal cell voltage threshold.
3. When the control unit determines that the first voltage exceeds the first normal cell voltage threshold, the control unit causes the current control device to cause a second current (first current>second current) smaller than the first current to flow through the water electrolysis cell, and measures the second voltage of each water electrolysis cell by the voltage sensor. The control unit compares the second voltage with the second normal cell voltage threshold and determines whether the second voltage is less than or equal to the second normal cell voltage threshold.
4. When the control unit determines that the second voltage exceeds the second normal cell voltage threshold, the control unit sweeps a predetermined current to the water electrolysis cell by the current control device, and calculates the second resistance of the water electrolysis cell from the slope of the voltage of the obtained water electrolysis cell. The control unit determines whether the second resistance is equal to or less than a predetermined resistance threshold. When the second resistance is higher than the predetermined resistance threshold value, the control unit determines that the water electrolysis cell is abnormal, and the control unit stops the operation of the water electrolysis cell as a treatment at the time of the abnormality. When the second resistance is equal to or less than the predetermined resistance threshold, the control unit continues the operation of the water electrolysis cell.
   In the first embodiment, since the first voltage is measured by the first current during the normal operation of the water electrolysis cell, the resistance may increase due to an overvoltage or the like. In the second embodiment, after the first voltage is measured, the second voltage is measured with a second current that is smaller than the first current and less affected by the resistance. The second current is not particularly limited as long as it is a current smaller than the first current.

The first normal cell voltage threshold and the second normal cell voltage threshold are collectively referred to as a normal cell voltage threshold (which may be simply referred to as a voltage threshold). The normal cell voltage threshold may be a voltage when the water electrolysis cell is activated and the operating hydrogen pressure is reached, or may be a voltage value when the resistance of the water electrolysis cell is checked by performing a current sweep due to a voltage increase or the like, and the resistance of the water electrolysis cell is within a normal range. When the water electrolysis cell is started up, the temperature of the water electrolysis cell is low, and after the sweep of the current, the temperature of the water electrolysis cell is higher than when the water electrolysis cell is started up, so that the normal cell voltage threshold value may be set again as appropriate in accordance with the state of the water electrolysis cell.

The resistance threshold may be a design lower limit of the cell. In the case of a pressure abnormality, the separator of the water electrolysis cell is deformed, thereby increasing the contact resistance in the water electrolysis cell. When the pressure in the water electrolysis cell exceeds the normal use range, the hydrogen pressure in the water electrolysis cell deforms the separator in the swelling direction as the water electrolysis cell. The separator is, for example, deformed to a dorayaki shape. As a result, the load that presses the separators against GDL is weakened, so that the contact-resistance of the separators is increased, and in the water electrolysis in which a constant current flows, the voltage is increased in order to maintain the current. Therefore, even if the pressure sensor fails, it is possible to determine whether or not an abnormality occurs by calculating the resistance of the water electrolysis cell.

What is claimed is:

1. A water electrolysis system, wherein:
a hydrogen pressure in a water electrolysis cell is measured, and when the hydrogen pressure is within a normal range, a first voltage at a first current when the water electrolysis cell is in normal operation is measured;
when the first voltage exceeds a first normal cell voltage threshold value at the first current, a first resistance of the water electrolysis cell is calculated from a slope of a voltage of the water electrolysis cell that is obtained by sweeping a predetermined current to the water electrolysis cell; and
when the first resistance is higher than a predetermined resistance threshold value, determination is made that the water electrolysis cell is abnormal, and an operation of the water electrolysis cell is stopped.

2. The water electrolysis system according to claim 1, wherein:
when the determination is made that the water electrolysis cell is abnormal, the operation of the water electrolysis cell is not stopped, and a second voltage at a second current smaller than the first current of the water electrolysis cell is measured;
when the second voltage exceeds a second normal cell voltage threshold value at the second current, a second resistance of the water electrolysis cell is calculated from the slope of the voltage of the water electrolysis cell obtained by sweeping the predetermined current to the water electrolysis cell; and
when the second resistance is higher than a predetermined resistance threshold value, the determination is made that the water electrolysis cell is abnormal, and the operation of the water electrolysis cell is stopped.

3. The water electrolysis system according to claim 1, wherein:
the water electrolysis system includes the water electrolysis cell, a control unit, a pressure sensor, and a voltage sensor;
the pressure sensor measures the hydrogen pressure in the water electrolysis cell;
when the control unit determines that the hydrogen pressure is within the normal range, the voltage sensor measures the first voltage at the first current when the water electrolysis cell is in the normal operation;
when the control unit determines that the first voltage exceeds the first normal cell voltage threshold value at the first current, the control unit calculates the first resistance of the water electrolysis cell from the slope of the voltage of the water electrolysis cell obtained by sweeping the predetermined current to the water electrolysis cell; and
when the first resistance is higher than the predetermined resistance threshold value, the control unit determines that the water electrolysis cell is abnormal and stops the operation of the water electrolysis cell.
